(19) United States
(12) Patent Application Publication
(10) Pub. No.: US 2013/0037756 A1
(43) Pub. Date: Feb. 14, 2013

(54) ELECTRODES FOR ELECTROCHEMICAL CAPACITOR AND ELECTROCHEMICAL CAPACITOR INCLUDING THE SAME

(71) Applicants: Hak Kwan KIM, Seoul (KR); Jun Hee Bae, Seoul (KR); Bae Kyun Kim, Gyeonggi-do (KR); Ho Jin Yun, Gyeonggi-do (KR)

(72) Inventors: Hak Kwan KIM, Seoul (KR); Jun Hee Bae, Seoul (KR); Bae Kyun Kim, Gyeonggi-do (KR); Ho Jin Yun, Gyeonggi-do (KR)

(73) Assignee: Samsung Electro-Mechanics Co., Ltd., Suwon (KR)

(21) Appl. No.: 13/567,696

(22) Filed: Aug. 6, 2012

(30) Foreign Application Priority Data
Aug. 12, 2011 (KR) 10-2011-0080764

(51) Int. Cl. H01G 9/042; H01B 1/04

(52) U.S. Cl. 252/502

(57) ABSTRACT

An electrode for an electrochemical capacitor including a carbon material that is doped and two types of conductive materials with different particle sizes, and an electrochemical capacitor including the same. The doped carbon material is used as the active material and the two types of conductive materials with different particle sizes are added between the active materials with a relatively large particle size, so that the electrode with high density can be prepared by increasing the amount of active material per unit volume, and can be efficiently used in a low resistance and high output electrochemical capacitor by increasing the filling density of the conductive material with excellent conductivity.

### CROSS REFERENCE(S) TO RELATED APPLICATIONS

This application claims the benefit under 35 U.S.C. Section 119 of Korean Patent Application Serial No. 10-2011-0080764, entitled “Electrodes for Electrochemical Capacitor and Electrochemical Capacitor Including the Same” filed on Aug. 12, 2011, which is hereby incorporated by reference in its entirety into this application.

### BACKGROUND OF THE INVENTION

1. Technical Field

The present invention relates to electrodes for an electrochemical capacitor and an electrochemical capacitor including the same.

2. Description of the Related Art

In general, since a supercapacitor mainly uses an electrostatic property, the supercapacitor is charged or discharged more than hundreds of thousands of times compared to a battery using an electrochemical reaction. Also, the supercapacitor can be semi-permanently used and its output density is several dozen to several hundred times higher than that of the battery since a charging/discharging speed is very high. Accordingly, the supercapacitor is being increasingly applied to various fields due to its characteristic, which cannot be achieved by an existing battery. In particular, utilization of the supercapacitor in a next-generation environmentally friendly vehicle field such as an electric car or a fuel cell car is increasing.

The supercapacitor may be connected to a battery and used along with the battery as an auxiliary energy storage device. In this case, the supercapacitor is in charge of instantaneous energy supply, whereas the battery is in charge of average energy supply for a vehicle. Therefore, it can be expected that efficiency of an overall vehicle system is improved and a lifespan of an energy storage system is extended. Also, since the supercapacitor may be used in heavy equipment such as an excavator, a UPS, an energy storage device for wind power or solar power, or a mobile electronic component such as a mobile phone or a moving picture recorder as a main/auxiliary power source, its importance is increasing and its purpose becomes diversified.

The supercapacitor may be generally divided into three types, an electric double layer capacitor (EDLC) in which adsorption/desorption of an electric charge acts as an electric charge accumulating mechanism, a pseudocapacitor which mainly uses an oxidation-reduction reaction, and a hybrid capacitor which combines the aforementioned capacitors.

Among these capacitors, the EDLC has an electric double layer generated on a surface and accumulates an electric charge, and the oxidation-reduction capacitor accumulates an electric charge using an oxidation-reduction reaction of a metallic oxide used as an active material.

The EDLC, which is most commonly used presently, uses an environmentally friendly carbon material that has outstanding safety as an electrode material. For example, the carbon material may be activated carbon, carbon nano tube (CNT), graphite, carbon aerogel, polyacrylonitrile (PAN), carbon nano fiber (CNF), activated carbon nano fiber (ACNF), vapor grown carbon fiber (VGCF), or graphene.

Also, carbon black, ketchen black, and acetylene black, which have a graphite plate shaped structure as a basic frame and which are conductive materials having relatively excellent electrical conductivity compared to the other carbon materials, are added and used as a conductive material to improve conductivity.

FIG. 1 illustrates a general structure of such a supercapacitor. Referring to FIG. 1, an anode 10 and a cathode 20 in which electrode active material layers 12 and 22 are formed on an anode collector 11 and a cathode collector 21 using a porous carbon material 13 are electrically separated from each other by a separation film 30. An electrolyte 40 is filled between the two electrodes, the anode 10 and the cathode 20, and the current collectors 11 and 12 charge or discharge the electrodes with electric charge efficiently, and the electrodes are finally sealed by a sealing part 50.

The activated carbon, which is used as the electrode active material of the supercapacitor and is a porous carbon material, is a porous material consisting of minute pores and has a wide specific surface area. Accordingly, if a negative charge (−) is applied to the electrode (anode 10) using the activated carbon, a positive (+) ion dissociated from the electrolyte enters the pores of the activated carbon electrode and forms a positive (+) layer. The positive (+) layer forms an electric double layer along with a negative (−) layer formed on an interface of the activated carbon electrode and charges an electric charge.

The supercapacitor has capacitance greatly depending on a structure and a physical property of the electrode, and its required characteristics are a wide specific surface area, a small internal resistance and a small contact resistance of the material itself, and high density of the carbon material.

Therefore, it is important to consider the fact that if the density of the electrode active material is low, the resistance generally increases and the capacitance decreases. As such, the density, the resistance, and the capacitance of the electrode prepared using the active material and the conductive material are closely related to one another.

In general, if a content of the conductive material increases, the resistance decreases due to high electrical conductivity that the conductive material has, but, the capacitance also decreases because an amount of the active material such as the activated carbon decreases.

On the other hand, if a content of the active material with high density increases, the capacitance increases, but the resistance also increases. Therefore, it is important to find an appropriate ratio between the active material and the conductive material (for example, about 8:1).

In other words, if the density of the electrode is low, the active material and the conductive material doe not contact each other efficiently and thus an ESR increases. Therefore, the capacitance decreases. Accordingly, an effort to solve this problem has been made up to now.

### SUMMARY OF THE INVENTION

The present invention has been developed in order to solve several problems that occur in configuring electrodes for an electrochemical capacitor such as a related art electric double layer capacitor, and an object of the present invention is to provide electrodes for an electrochemical capacitor which can improve various characteristics such as energy density, capacitance, and electric resistance.

Another object of the present invention is to provide an electrochemical capacitor which includes the above electrodes.

According to an exemplary embodiment of the present invention, there is provided an electrode for an electrochemical capacitor including: a carbon material that is doped; and two types of conductive materials with different particle sizes.

The carbon material may be doped using one or more materials selected from the group consisting of nitrogen (N) and boron (B).

The carbon material may be an activated carbon which has a specific surface area of 1500˜3000 m²/g.

The two types of conductive material with the different particle sizes may include a first conductive material which has a size of 9˜10% of the carbon material, and a second conductive material which has a size relatively smaller than the size of the first conductive material.

The particle size of the first conductive material may be 1˜2 μm.

The first conductive material may be one or more materials selected from the group consisting of graphite, conductive ceramics, conductive oxide, and metal.

The particle size of the second conductive material may be 10˜900 nm.

The second conductive material may be one or more conductive carbons selected from the group consisting of graphite, carbon black, acetylene black, carbon nano tube, carbon nano fiber, graphene, and conductive glassy carbon.

The carbon material may be doped using one method selected from a plasma processing method, a heat treatment method after CVD, and a heat treatment method in a doping gas atmosphere.

According to another exemplary embodiment of the present invention, there is provided an electrochemical capacitor including an electrode including: a carbon material that is doped; and two types of conductive materials with different particle sizes.

The electrode may be one selected from an anode and/or a cathode.

### BRIEF DESCRIPTION OF THE DRAWINGS

FIG. 1 is a view illustrating a structure of a general supercapacitor; and

FIG. 2 is a view illustrating an example of a pattern in which an electrode active material and two types of conductive materials are distributed according to the present invention.

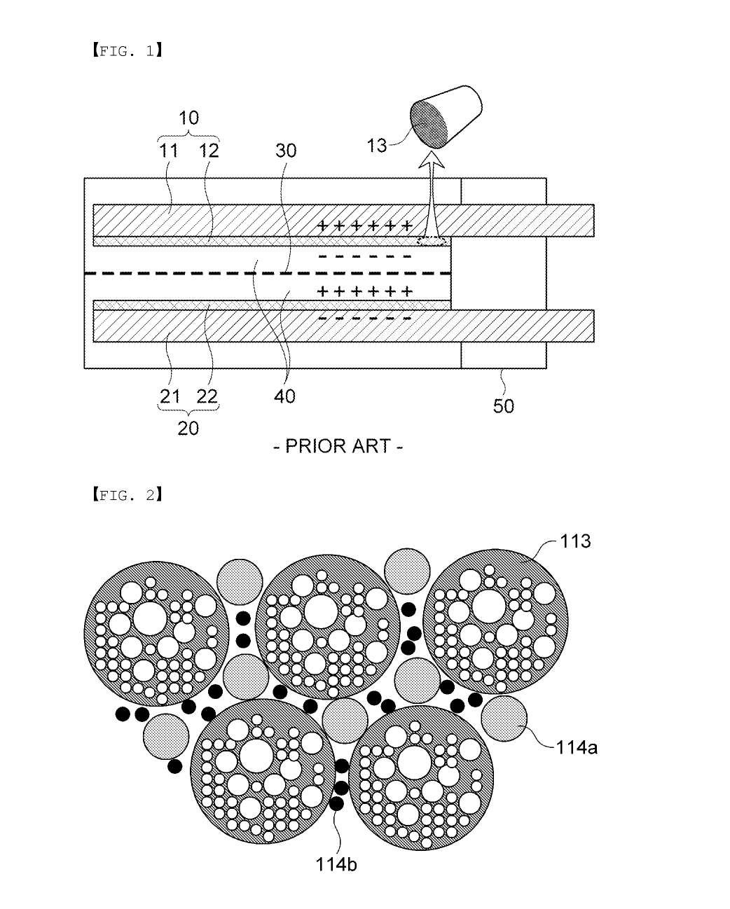

### DESCRIPTION OF THE PREFERRED EMBODIMENTS

Hereinafter, exemplary embodiments will be described in detail with reference to the accompanying drawings.

The terms used in the present specification and claims should not be interpreted as being limited to typical meanings or dictionary definitions. In the following description, the singular expression is intended to include the plural expression unless the context clearly indicates otherwise. The terms ‘comprises’ and/or ‘comprising’ used in the specification and claims specifically define the presence of mentioned shapes, figures, steps, operations, elements, components, and/or groups and do not preclude the presence or addition of one or more other shapes, figures, operations, elements, components, and/or groups.

The present invention relates to electrodes for an electrochemical capacitor and an electrochemical capacitor including the same.

The electrode of the electrochemical capacitor according to an exemplary embodiment may include a doped carbon material and two types of conductive materials with different particle sizes.

The electrode of the present invention includes a doped carbon material 113 and two types of conductive materials with different particle sizes. The two types of conductive materials with the different particle sizes are a first conductive material 114a and a second conductive material 114b, and an example of a pattern in which these conductive materials are mixed and distributed is shown in FIG. 2.

The doped carbon material 113 acts as an electrode active material and may be an activated carbon having a specific surface area of 1500˜3000 m²/g. The activated carbon is applicable to all activated carbons used in the field of the supercapacitor and is not limited by an activation processing method and a type of raw material.

As shown in FIG. 2, the activated carbon 113, which is the doped carbon material, may have a porous structure with a plurality of great and small pores on its surface.

In the present invention, the activated carbon is not used as it is and it is preferable to use an activated carbon which is doped using one or more materials selected from the group consisting of nitrogen (N) and boron (B) having polarity by allowing an electron or hole to act as a main carrier, in order to reform a surface property of the activated carbon.

In the case of the activated carbon with the reformed surface property, electrical conductivity of the activated carbon increases by forming the electron or the hole as the carrier by substituting nitrogen or boron with a carbon element on the surface, and ultimately, the ESR of the electrode is reduced.

Also, a space charge layer capacitance is generated as the density of the electron or the hole increases, and the activated carbon becomes a donor of the electron or the hole and thus contributes to pseudocapacitance by means of faradic charge transfer, and as a result, the capacitance of the capacitor increases.

From a different perspective, if the carbon material doped by the above-described doping material is used as the electrode active material, a functional group on an activated carbon powdered surface increases and thus an amount of ions of the electrolyte adsorbed onto/desorbed from a surface of the active material increases. That is, a capacitance contribution ratio of the electrolyte ion increases resulting in an increased capacitance of the electrode.

The carbon material surface is doped with the above doping material by a plasma processing method, a heat treatment method after chemical vapor deposition (CVD), or a heat treatment method in a doping gas atmosphere. Among these methods, the plasma processing method may be most widely used.

The plasma processing method may perform a hydrogen plasma processing operation to reduce a hydrogen gas to an activated carbon at a constant speed, and a nitrogen plasma processing operation to apply a nitrogen gas at a constant speed. Next, any impurities remaining on the surface is removed by a heat treatment process.

Using the doped carbon material in the electrode is effective in increasing the capacitance. However, there is a risk of an increase in resistance due to disturbance of the movement of the electron. Accordingly, in order to prevent this problem, the present invention aims at manufacturing an electrochemical capacitor with a low resistance by increasing a conductive material filling ratio.

To achieve this, charging density is maximized using two or more types of conductive materials with different particle sizes as a conductive material for the electrode of the present invention.

Accordingly, the first conductive material according to the present invention may be a material that has a sufficient size to occupy a space generated by filling a primarily doped activated carbon powder, has excellent conductivity, and has great electrostatic capacitance.

A particle size of the first conductive material may be about 9˜10% of a size of the doped carbon material. That is, the particle size of the first conductive material may be 1˜2 μm.

For example, the first conductive material may be, but not limited to, one or more materials selected from the group consisting of graphite, conductive ceramics (for example, titanium carbide or titanium nitride), a conductive oxide (for example, a vanadium oxide, a titanium oxide, a manganese oxide, or a nickel oxide), and metal.

Next, as shown in FIG. 2, the first conductive material 114a is included between the doped carbon materials 113, which are used as the electrode active material, thereby increasing an amount of active material per unit volume, and accordingly, may be used to prepare the electrode having high density.

However, empty spaces may still exist between the doped carbon materials 113 with only the first conductive material 114a. Accordingly, by adding the second conductive material 114b which has a particle size relatively smaller than that of the first conductive material 114a, the empty spaces between the doped carbon material 113 and the first conductive material 114a are filled so that the resistance can be minimized.

A particle size of the second conductive material 114b may be 10˜900 nm. For example, the second conductive material 114b may be, but not limited to, one or more conductive carbons selected from the group consisting of graphite, carbon black, acetylene black, carbon nano tube, carbon nano fiber, graphene, and conductive glassy carbon.

The amount of active material per unit volume is increased by means of the above-described electrode structure so that the electrode having high density can be prepared, and the two types of conductive materials with the different particle sizes, which have excellent conductivity, are included, thereby contributing to the low resistance and high output characteristics.

The electrode of the present invention may include a binder, a solvent, and other additives to bind the electrode active material and the conductive material, in addition to the above-described components. Also, examples of the binder, the solvent, and other additives are not specifically limited and any material used in a general electrochemical capacitor may be used within a usual content range.

Also, the present invention may provide an electrochemical capacitor including the above electrode. The electrode of the present invention may be used in an anode and/or a cathode.

The electrolyte, the current collector, the separation film configuring the electrochemical capacitor of the present invention are not specifically defined, and any one that can be used in a general electrochemical capacitor such as an electric double layer capacitor may be used and a detailed description thereof is omitted.

Also, the electrochemical capacitor may be used in the electric double layer capacitor, but is not limited thereto.

### Example 1

### Preparation of Electrode Active Material Slurry Composition

Electrode active material slurry was prepared by mixing 85 g of activated carbon (a specific surface area of 2150 m²/g) which has been nitrogen plasma-processed, 5 g of graphite as the first conductive material, 12 g of Super-P as the second conductive material, 3.5 g of CMC as the binder, 12.0 g of SBR, 5.5 g of PTFE, and 225 g of water, and agitating this mixture.

### Comparative Example 1

Electrode active material slurry was prepared by mixing 85 g of general activated carbon (a specific surface area of 2150 m²/g) which has not been surface-processed, 12 g of acetylene black as a single conductive material, 3.5 g of CMC as a binder, 12.0 g of SBR, 5.5 g of PTFE, and 225 g of water, and agitating this mixture.

### Example 2 & Comparative Example 2

### Preparation of Electrochemical Capacitor

1) Preparation of Electrode

The electrode active material slurries according to the above Example 1 and Comparative example 1 were coated over an aluminum etching film having a thickness of 20 μm using a comma coater, were dried temporarily, and then were cut into electrodes of 50 mm×100 mm. Cross-sectional thickness of the electrode was 60 μm. Before assembling a cell, the electrodes were dried in a vacuum at 120° C. for 48 hours.

2) Preparation of Electrolyte

An electrolyte was prepared by dissolving spiro salt in acrylonitrile solvent to have a concentration of 1.3 mol/liter.

3) Assembling of Capacitor Cell

A separator (TF4035 NKK, a cellulose separation film) was inserted between the prepared electrodes (anode and cathode), and the electrodes were impregnated with the electrolyte, were inserted into a laminate film case and then were sealed.

### Experimental Example

### Evaluation of Capacitance of Electrochemical Capacitor Cell

Under a constant temperature condition of 25° C., the cell was charged up to 2.5V with current density of 1 mA/cm² at a constant current-constant voltage and was maintained for 30 minutes. Thereafter, the cell was discharged at a constant current of 1 mA/cm² three times and capacitance of a final cycle was measured. The resulting capacitance is shown in table 1 below. A resistance characteristic of each cell was measured by an ampere-ohm meter and an impedance spectroscopy and the resulting resistance characteristic is shown in table 1 below:

TABLE 1

| | Initial | Resistance |
|---|---|---|
| | Capacitance | Characteristic (AC, |
| Type | Characteristic (F) | ESR, mΩ) |
| Comparative Example 2 | 10.55 | 19.11 |
| Example 2 | 11.38 | 10.92 |

As shown in table 1 above, the capacitance of the electrochemical capacitor (EDLC cell) in Comparative example 2, which includes the electrodes using the active material slurry prepared to have a general electrode active material slurry composition according to Comparative example 1, is 10.55 F, and the resistance value is 19.11 mΩ.

On the other hand, the capacitance of the electrochemical capacitor (EDLC cell) in Example 2, which includes the electrodes prepared from the electrode active material slurry that was prepared by mixing the activated carbon doped with the doping material and the conductive materials with different types and different sizes according to Example 1, is 11.38 F, and the resistance value is 10.92 mΩ.

As a result, the electrode having high density can be prepared by increasing the amount of active material per unit volume through the above-described electrode structure, and the two types of conductive materials with the different particle sizes, which have excellent conductivity, are included so that the cell showing low resistance and high output characteristics can be manufactured.

According to the present invention, the doped carbon material is used as the active material and the two types of conductive materials with different particle sizes are added between the active materials with relatively large particle size, so that the electrode with high density can be prepared by increasing the amount of active material per unit volume, and can be efficiently used in a low resistance and high output electrochemical capacitor by increasing the filling density of the conductive material with excellent conductivity.

While the present invention has been shown and described in connection with the embodiments, it will be apparent to those skilled in the art that modifications and variations can be made without departing from the spirit and scope of the invention as defined by the appended claims.

What is claimed is:

1. An electrode for an electrochemical capacitor comprising:
a carbon material that is doped; and
two types of conductive materials with different particle sizes.

2. The electrode according to claim 1, wherein the carbon material is doped using nitrogen or boron.

3. The electrode according to claim 1, wherein the carbon material is an activated carbon which has a specific surface area of 1500˜3000 m²/g.

4. The electrode according to claim 1, wherein the two types of conductive material with the different particle sizes include a first conductive material which has a size of 9˜10% of the carbon material, and a second conductive material which has a size relatively smaller than the size of the first conductive material.

5. The electrode according to claim 4, wherein the particle size of the first conductive material is 1˜2 μm.

6. The electrode according to claim 4, wherein the first conductive material is one or more materials selected from the group consisting of graphite, conductive ceramics, conductive oxide, and metal.

7. The electrode according to claim 4, wherein the particle size of the second conductive material is 10˜900 nm.

8. The electrode according to claim 4, wherein the second conductive material is one or more conductive carbons selected from the group consisting of graphite, carbon black, acetylene black, carbon nano tube, carbon nano fiber, graphene, and conductive glassy carbon.

9. The electrode according to claim 1, wherein the carbon material is doped using one method selected from a plasma processing method, a heat treatment method after CVD, and a heat treatment method in a doping gas atmosphere.

10. An electrochemical capacitor including the electrode according to claim 1.

11. The electrochemical capacitor according to claim 10, wherein the electrode is one selected from an anode and/or a cathode.
